(19) United States
(12) Patent Application Publication
(10) Pub. No.: US 2018/0011854 A1
(43) Pub. Date: Jan. 11, 2018

(54) METHOD AND SYSTEM FOR RANKING CONTENT ITEMS BASED ON USER ENGAGEMENT SIGNALS

(71) Applicant: Yahoo Holdings, Inc., Sunnyvale, CA (US)

(72) Inventors: Xing Yi, Milpitas, CA (US); Liangjie Hong, Santa Clara, CA (US); Yue Shi, Sunnyvale, CA (US); Suju Rajan, Sunnyvale, CA (US); Alyssa Glass, Sunnyvale, CA (US); Zhen Yue, Santa Clara, CA (US)

(21) Appl. No.: 15/204,009

(22) Filed: Jul. 7, 2016

(51) Int. Cl. G06F 17/30; G06N 99/00

(52) U.S. Cl. CPC G06F 17/3053; G06N 99/005

(57) ABSTRACT

The present teaching relates to method, system, and programs for training a ranking model for ranking content items. In one example, a set of content items is obtained. A plurality types of online user activities performed with respect to the set of content items are obtained. For each of the set of content items, a plurality of user engagement scores are determined. Each of the plurality of user engagement scores is determined based on a corresponding one of the plurality types of online user activities. For each of the set of content items, an aggregated score is calculated based on the plurality of user engagement scores to generate aggregated scores. A ranking model is trained based on the aggregated scores.

### BACKGROUND

### 1. Technical Field

The present teaching relates to methods, systems and programming for ranking content items. Particularly, the present teaching is directed to methods, systems, and programming for ranking content items based on a plurality of user engagement signals.

### 2. Discussion of Technical Background

The Internet has made it possible for a user to electronically access virtually any content at any time and from any location. With the explosion of information, it has become increasingly important to provide users with information that is relevant to the user. Further, as users of today's society rely on the Internet as their source of information, entertainment, and/or social connections, e.g., news, social interaction, movies, music, etc., it is critical to provide users with information they find valuable.

Efforts have been made to attempt to enable users to readily access relevant content. As an example, there are systems that identify users' interests based on observations made on users' interactions with content. In the context of search, for instance, observations regarding user engagement with search results are typically facilitated via click-based signals. In particular, a system determines that a content item has been accessed by a user when the user “clicks” a search result link to access the content item as a result of the selected link containing a URL that identifies the accessed content item. As such, by monitoring which search result links are clicked by users, the system can determine which content items are accessed by users and, thus, determine which content items (or their associated search result links) are more interesting to the users overall and/or on a query basis. Such determinations may then be used to personalize the content or the search results links that are provided to users during subsequent queries or other user activities, e.g. to rank the search results or recommended content items.

However, in the context of mobile, a list of search result links may not be as practical. When approaches other than the traditional list of search result links are utilized to enable users to access content items related to a query, analysis of user engagement merely based on a single type of signal, e.g. a click-based signal, may not be enough to optimize a ranking model. In addition, traditional methods of ranking model optimization need many human inputs or human-labeled data as optimization targets, which is expensive and cannot be scaled up. Thus, there is a need for ranking content items based on a plurality of user engagement signals without the above mentioned drawbacks.

### SUMMARY

The present teaching relates to methods, systems and programming for ranking content items. Particularly, the present teaching is directed to methods, systems, and programming for ranking content items based on a plurality of user engagement signals.

In one example, a method, implemented on at least one machine each of which has at least one processor, storage, and a communication platform connected to a network for training a ranking model, is disclosed. A set of content items is obtained. A plurality types of online user activities performed with respect to the set of content items are obtained. For each of the set of content items, a plurality of user engagement scores are determined. Each of the plurality of user engagement scores is determined based on a corresponding one of the plurality types of online user activities. For each of the set of content items, an aggregated score is calculated based on the plurality of user engagement scores to generate aggregated scores. A ranking model is trained based on the aggregated scores.

In a different example, a system having at least one processor, storage, and a communication platform connected to a network for training a ranking model is disclosed. The system includes: a user engagement signal extractor configured for: obtaining a set of content items, and obtaining a plurality types of online user activities performed with respect to the set of content items; a user engagement signal normalizer configured for determining, for each of the set of content items, a plurality of user engagement scores each of which is determined based on a corresponding one of the plurality types of online user activities; a user engagement signal aggregator configured for calculating, for each of the set of content items, an aggregated score based on the plurality of user engagement scores to generate aggregated scores; and a card ranking model generator for training a ranking model based on the aggregated scores.

Other concepts relate to software for training a ranking model for ranking content items. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine-readable tangible and non-transitory medium has information recorded thereon for training a ranking model, wherein the information, when read by the machine, causes the machine to perform a series of steps. A set of content items is obtained. A plurality types of online user activities performed with respect to the set of content items are obtained. For each of the set of content items, a plurality of user engagement scores are determined. Each of the plurality of user engagement scores is determined based on a corresponding one of the plurality types of online user activities. For each of the set of content items, an aggregated score is calculated based on the plurality of user engagement scores to generate aggregated scores. A ranking model is trained based on the aggregated scores.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a high level depiction of an exemplary networked environment for an optimization of card ranking, according to an embodiment of the present teaching;

FIG. 2 is a high level depiction of another exemplary networked environment for an optimization of card ranking, according to an embodiment of the present teaching;

FIG. 3 illustrates different exemplary cards, according to an embodiment of the present teaching;

FIG. 4 illustrates different card level user engagement signals, according to an embodiment of the present teaching;

FIG. 5 illustrates different context information that may be used for optimization of card ranking, according to an embodiment of the present teaching;

FIG. 6 illustrates a screen on a mobile device where user activities regarding different cards may be performed, according to an embodiment of the present teaching;

FIG. 7 is a high level exemplary system diagram of a user engagement based card ranking system, according to an embodiment of the present teaching;

FIG. 8 is a flowchart of an exemplary process performed by a user engagement based card ranking system, according to an embodiment of the present teaching;

FIG. 9 illustrates an exemplary diagram of a user engagement signal normalizer, according to an embodiment of the present teaching;

FIG. 10 is a flowchart of an exemplary process performed by a user engagement signal normalizer, according to an embodiment of the present teaching;

FIG. 11 illustrates an exemplary diagram of a user engagement signal aggregator, according to an embodiment of the present teaching;

FIG. 12 is a flowchart of an exemplary process performed by a user engagement signal aggregator, according to an embodiment of the present teaching;

FIG. 13 illustrates an exemplary diagram of a card ranking model generator, according to an embodiment of the present teaching;

FIG. 14 is a flowchart of an exemplary process performed by a card ranking model generator, according to an embodiment of the present teaching;

FIG. 15 depicts the architecture of a mobile device which can be used to implement a specialized system incorporating the present teaching; and

FIG. 16 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching relates to ranking content items based on a plurality of user engagement signals. In various embodiments, a presentation of a content item is provided on a user interface to a user, either for recommendation to the user or in response to a query submitted by the user. In some embodiments, the content item is an information card. Other content items can, for example, be presented as information in respective portions of the information card. In other embodiments, the content item comprises at least one of a webpage, a video, an image, an audio, a document, or other content item. User activities related to the content item is monitored, and user engagement signals are generated and collected based on the monitored user activities.

According to an embodiment of the present teaching, a ranking system can combine and leverage the card-level user engagement and interaction signals for optimizing card ranking models for card-based mobile information guide systems, including but not limited to mobile search, mobile recommendation, and mobile contextual search systems. The ranking system may combine all different types of user engagement signals, including but not limited to click/skip, pre-click browsing time, post-click dwell time, swipe and reformulations, and extract card-level relevancy sores based on the card-type (such as interactive-card like news card, or non-interactive/clickable card like weather card) to rank content item targets for the above systems. According to various embodiments, a method is proposed herein to determine different weights and normalizations for using different types of user engagement signals as graded ranking targets to achieve best online user satisfaction.

The present teaching also discloses aggregating and using card-level user engagement signals in different ways (such as taking the max/min/average) given different contexts as ranking features used in the machine learning ranking (MLR) models instead of ranking targets, to achieve best online ranking performance. The contexts may include different combinations of (Time, Query n-gram Tokens, Card), (Time, Card), (Query n-gram Tokens, Card), etc. Some of these ranking features can be computed offline using large amount of historical user activity logs; while others can be computed online using real-time user log analysis pipelines such as the click-feedback pipelines.

The present teaching also discloses using card-level user engagement signals for both input ranking features and ranking targets, where the ranking system carefully computes and chooses the set of user engagement signals used for ranking features and the ones used for ranking targets. A newly learned or trained MLR model can then be tested both offline using some human-annotation data or through online AB tests for selecting the best one for the production.

The present teaching can provide a general solution for using card-level user engagement and interaction signals for optimizing card ranking models for card-based mobile information guide systems. The ranking system disclosed in the present teaching may normalize and weighted-combine card-level user engagement signals from different card types for optimizing card ranking, to provide different types of cards (such as news card, image card, Mail card, video card, local card) into one unified rank list for presentation to the users. The ranking system disclosed in the present teaching may leverage card-level user engagement signals as either MLR models' input features or ranking targets to optimize towards the best user satisfaction for card-based mobile information guide systems.

In one embodiment, the ranking system disclosed in the present teaching may work alone to extract data and signals to train MLR models at scale towards better user engagement which can cover large number of tail cases. In another embodiment, the ranking system disclosed in the present teaching can be combined with editorial judgment data to train MLR models that achieve the best offline ranking performance.

Different from a human-annotated approach, the method disclosed in the present teaching can be used to effectively collect large-scale training data to better optimize/train machine learning based card ranking models for card-based mobile information guide products. The system disclosed in the present teaching can combine different types of card-level positive/negative user engagement signals mined from large-scale user activity logs and use them as both ranking features and ranking targets for MLR models, in order to better optimize user experience for those products. The method may be particularly useful when being applied for personal information involved recommendation or assistance systems, where collecting editorial labels is not only expensive but also generating additional issues such as privacy and the difficulty of judging relevance with incomplete information about the context related to the users.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

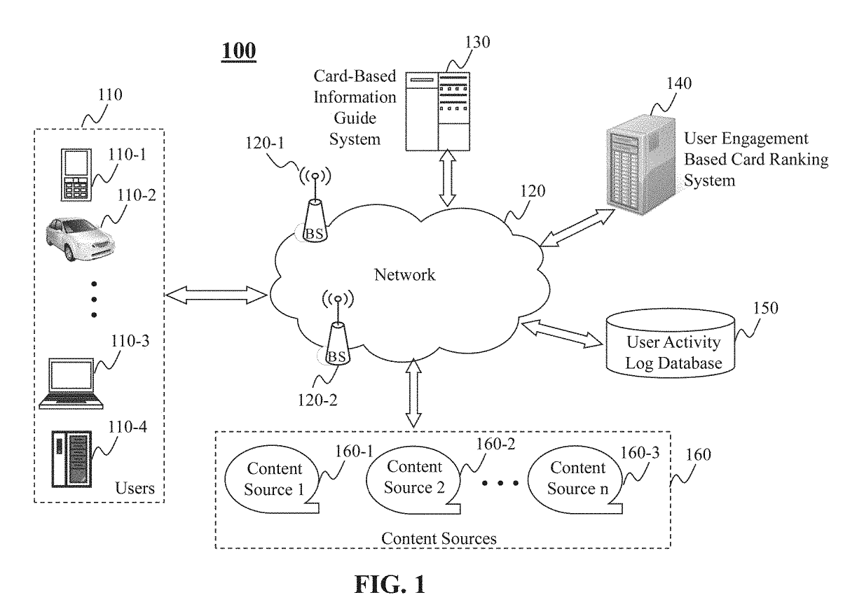

FIG. 1 is a high level depiction of an exemplary networked environment 100 for an optimization of card ranking, according to an embodiment of the present teaching. The exemplary system 100 includes users 110, a network 120, a card-based information guide system 130, a user engagement based card ranking system 140, a user activity log database 150, and content sources 160. The network 120 in system 100 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. A network may also include various network access points, e.g., wired or wireless access points such as base stations or Internet exchange points 120-1, 120-2, through which a data source may connect to the network in order to transmit information via the network.

Users 110 may be of different types such as users connected to the network via desktop connections (110-4), users connecting to the network via wireless connections such as through a laptop (110-3), a handheld device (110-2), or a built-in device in a motor vehicle (110-1).

In some embodiments, a user may submit a query to the card-based information guide system 130 via the network 120 and receive a query result from the card-based information guide system 130 through the network 120. In some embodiments, the user may be provided with a presentation of content items without first being provided with an intermediate set of results related to the query after the submission of the query and before the presentation of the content items. For example, the presentation of the content items may be provided to the user without first presenting the user with a list of search result links and requiring the user to select (e.g., by clicking, tapping, etc.) one of the presented search result links to be provided with a presentation of one of the content items.

In some other embodiments, the card-based information guide system 130 may proactively provide recommended content items to a user via the network 120 without receiving any query from the user.

In some embodiments, a browser (or other application) at a user device monitors activities at the user device, such as when a presentation of a content item is loaded on the browser, when certain user activities (e.g., actions, in-actions, etc.) related to the content item occurs, etc. Responsive to the monitoring, the browser (or other application) may generate information regarding the user activities, information regarding the timing of the presentation or the user activities, or other information. Subsequently, the generated information may be transmitted to one or more servers (e.g., a server comprising the card-based information guide system 130, the user engagement based card ranking system 140, or both) and/or stored in the user activity log database 150.

The user activity log database 150 in this example can log all the user-issued queries, the context when the user contacts the back-end server, including the timestamp, location, user information and the device information, the card ranking results corresponding to each search or recommendation task, as well as user actions and interactions with the cards in the server-returned results. Thus, the user engagement based card ranking system 140 may use the user activity logs in the user activity log database 150 to extract and compute card-level user engagement signals and activities and use them for card ranking optimization.

The user engagement based card ranking system 140 can extract different types of user engagement signals from the user activity log database 150 and combine these signals to train a ranking model. The user engagement based card ranking system 140 may normalize the different types of user engagement signals into different user engagement scores and aggregate the user engagement scores based on pre-determined aggregation weights. The pre-determined aggregation weights may be generated and determined by the user engagement based card ranking system 140 using a regression approach, e.g. a linear regression or a logistic regression, based on some human labeled data. The user engagement based card ranking system 140 may update the aggregation weights from time to time.

The user engagement based card ranking system 140 may use the ranking model to rank a list of content items to be presented by the card-based information guide system 130 to a user. For example, after the user submits a query to the card-based information guide system 130, the card-based information guide system 130 may generate a list of information cards to be presented to the user on a mobile device. The user engagement based card ranking system 140 can help to rank the information cards based on the trained model such that the card-based information guide system 130 can send the ranked information cards to the user.

The content sources 160 include multiple content sources 160-1, 160-2 . . . 160-3. A content source may correspond to a web page host corresponding to an entity, whether an individual, a business, or an organization such as USPTO.gov, a content provider such as cnn.com and Yahoo.com, or a content feed source such as Twitter or blogs. Both the card-based information guide system 130 and the user engagement based card ranking system 140 may access information from any of the content sources 160-1, 160-2 . . . 160-3 and rely on such information to respond to a query (e.g., the card-based information guide system 130 identifies content related to keywords in the query and returns the result to a user) or provide published or recommended content to a user.

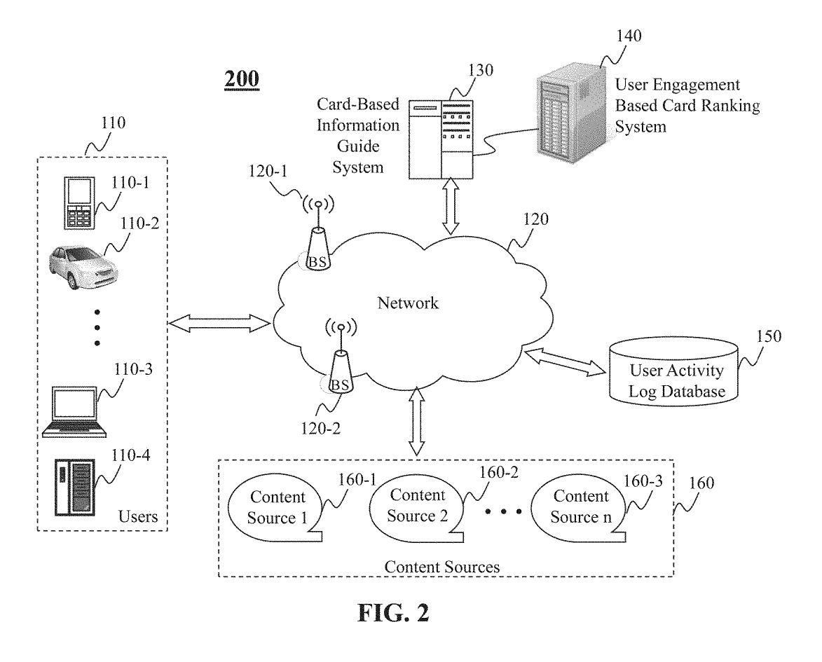

FIG. 2 is a high level depiction of another exemplary networked environment 200 for an optimization of card ranking, according to an embodiment of the present teaching. The exemplary networked environment 200 in this embodiment is similar to the exemplary networked environment 100 in FIG. 1, except that the user engagement based card ranking system 140 in this embodiment connects to the network 120 via the card-based information guide system 130. For example, the user engagement based card ranking system 140 may serve as a backend system of the card-based information guide system 130.

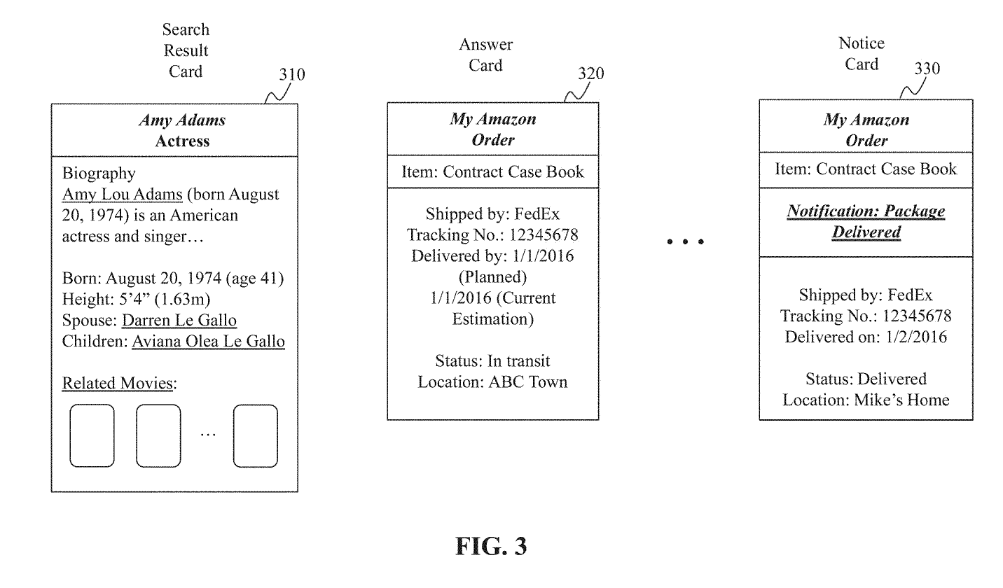

FIG. 3 illustrates different exemplary cards, according to an embodiment of the present teaching. As shown in FIG. 3, an information card may include but not limited to: a search result card 310, an answer card 320, and a notice card 330. It can be understood that the shape, size, and layout of the cards in FIG. 3 are for illustrative purpose only and may vary in other examples. In some embodiments, the shape, size, and layout may be dynamically adjusted to fit the specification of the user device (e.g., screen size, display resolution, etc.).

The search result card 310 in this example may be dynamically constructed on-the-fly in response to a query “amy adams.” Based on the type of the card (a search results card) and intent (learning more about actor Amy Adams), the layout and modules can be determined as shown in FIG. 3. In this example, the search result card 310 includes a header module with the name and occupation of Amy Adams. The search result card 310 also includes information about a biography of Amy Adams, her date of birth, her height, her spouse and children, and her movies. The names in the search result card 310 may be actionable. For example, after a user clicks on the name of her spouse “Darren Le Gallo,” another card related to Darren Le Gallo may be presented to the user. In the movies section, each movie may be presented in a “mini card” with the movie's name, release year, poster, and brief instruction, which may be retrieved from www.IMDB.com. The movie section may be actionable so that a person can swap the “mini cards” to see information of more movies of hers. In this example, the search result card 310 is an interactive card where users can click the card. Other interactive cards may include news cards and local cards.

The answer card 320 in this example may be dynamically constructed on-the-fly in response to a question “what is the status of my amazon order?” Based on the type of the card (answer card) and intent (finding out the status of my amazon order), the layout and modules can be determined as shown in FIG. 3. The answer card 320 includes a header module “My Amazon Oder” and an order module with entities of item. Price information may be added to the order module. The answer card 320 also includes a shipping module with entities of shipping carrier, tracking number, scheduled delivery date, current estimated delivery date, status, and location etc. The information in the shipping module may be retrieved from an email of the user or from the shipping carrier FedEx. In this example, the answer card 320 is a non-interactive card where users tend to only browse the cards. Other non-interactive cards may include weather cards.

The notice card 330 in this example may be automatically generated in response to any event that affects the status of the amazon order. Compared to the answer card 320, the notice card 330 includes an additional notification module. If any other information is affected or updated due to the event, it may be highlighted as well to bring to the person's attention. According to the notice card 330, the package has been delivered to Mike's home. This 330 may be either interactive or non-interactive. For example, the notification module may be interactive, such that after a user clicks on it, a web page card from FedEx may be presented to show more detailed information about the delivery.

It can be understood that the examples described above are for illustrative purpose and are not intended to be limiting.

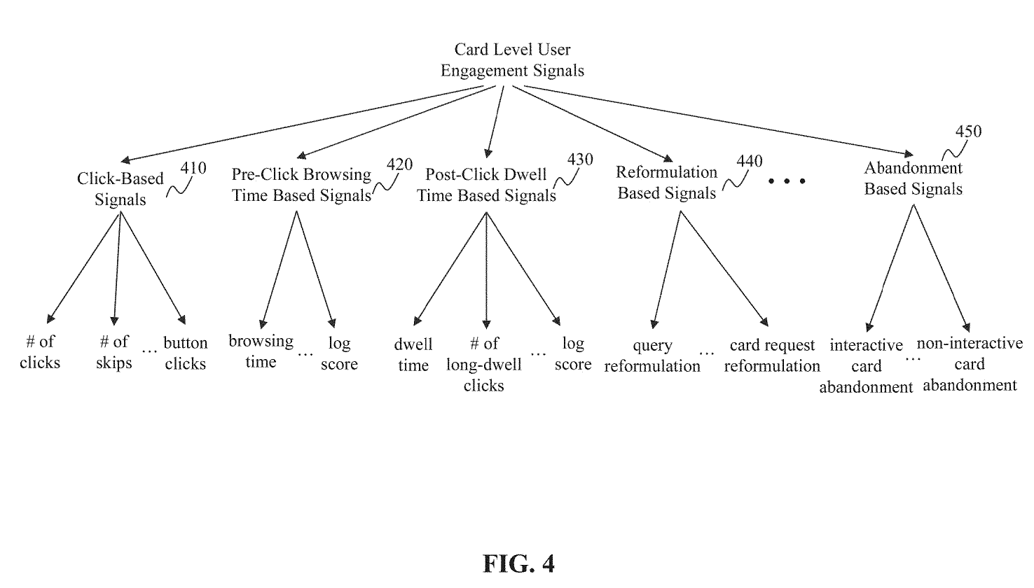

FIG. 4 illustrates different card level user engagement signals, according to an embodiment of the present teaching. User activities regarding an information card may comprise a user activity related to manipulation of the content item, a user activity related to manipulation of the presentation of the content item, a user activity related to manipulation of metadata associated with the content item, or other manipulated-related user activity. Based on these user activities, the system disclosed in the present teaching may determine many types of card-level user engagement signals for each pair of (card, query). The user engagement signals may be different for different card-types: interactive cards where users can click the cards (such as news cards and local cards), and non-interactive question-answer type cards where users tend to only browse the cards (such as the weather card and question-answer cards).

As shown in FIG. 4, there are different types of user engagement signals including but not limited to: (1) click-based positive/negative signals 410 (only interactive cards have this family of signals); (2) pre-click browsing time based positive/negative signals 420 (all cards have this family of signals); (3) post-click dwell time based positive/negative signals 430 (only interactive cards have this family of signals); (4) reformulation-based negative signals 440 (all cards have this family of signals); (5) abandonment-based positive/negative signals 450.

For each pair of (card, query), the click-based signals 410 may include: the number of clicks; the number of skips, where “skips” means other cards or results below a given card in a list is clicked; whether the card is clicked or skipped; whether there is an action-type button click or not (e.g. clicking on “call” button in a contact card or local card; clicking on “menu” button in a local restaurant card.). The clicks may be treated as positive signals while skips may be treated as negative signals.

The pre-click browsing time based signals 420 may include: whether the pre-click browsing time is longer than certain threshold, e.g. 30 s; or the log (browsing time) score. Here, long-browsing may be treated as a positive signal, such that the longer the browsing time of a card is, the higher its relevance score for the query is.

The post-click dwell time based signals 430 may include: whether a card has long-dwell clicks, where long-dwell threshold is a fixed value (such as 30 s) or predefined different value based on the card-type (e.g. 2 s for image card, 15 s for Mail card, 30 s for web card); the number of long-dwell clicks; or the log (dwell time) score. Here, a long dwell time may be a positive signal, such that the longer the dwell time of a card click is, the higher its relevance score for the query is.

To give an example of reformulation-based signals 440, one can assume there is a query reformulation pair (q1->q2), where q2 reformulates q1 and cards are from user-viewed q1's search result page. Then for each viewed (interactive card, q2), if it does not have long-dwell click, it can be used as a negative data-point.

The abandonment-based signals 450 may include: whether the question-answer type card is abandoned or not; whether the interactive-type card is abandoned or not, etc.

In some embodiments, a content item is recommended to a user without any query. In that case, the user engagement signals are determined with respect to each card, and the relevance score for each card may be a general user satisfaction score determined based on the user engagement signals.

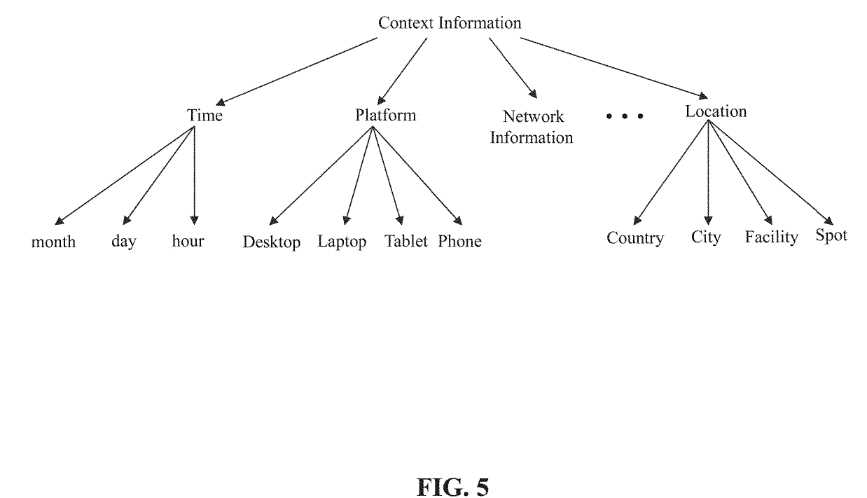

FIG. 5 illustrates different context information that may be used for optimization of card ranking, according to an embodiment of the present teaching. As shown in FIG. 5, the contextual information may be related to different types of online user activities. For example the contextual information may include time and location for a user activity, user information, user device information and network information related to a user activity, etc. The contextual information may also be utilized, in addition to the user activities themselves, for training a ranking model.

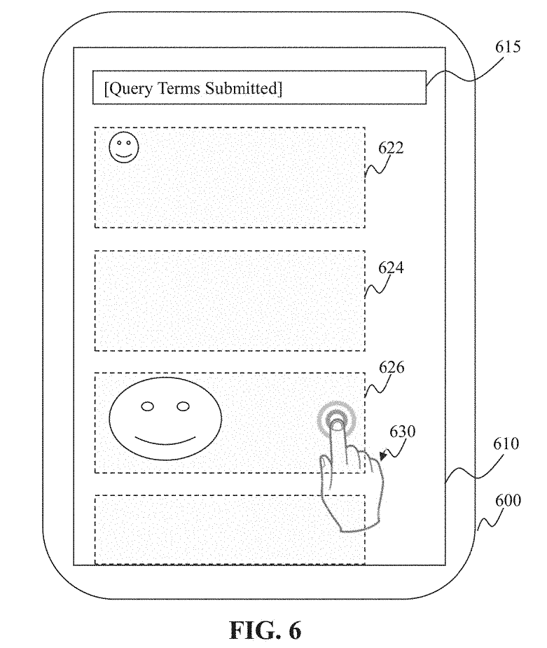

FIG. 6 illustrates a screen 610 on a mobile device 600 where user activities regarding different cards may be performed, according to an embodiment of the present teaching. As discussed before, in the context of mobile or other similar environments, search results can be presented as “cards” that are loaded with content relevant to a user query, reducing the need for a user to click/tap on a link to access an external or third party site that comprise the same content. FIG. 6 illustrates a user interface 610 on the mobile device 600 after a user has submitted query terms in query input area 615. In response to the submission of the query terms, a stack of information cards 622, 624, 626 is presented to the user on the user interface 610. As shown, in some embodiments, the presentation of the information cards is provided to a user without providing an intermediate set of results related to the query after the receipt of the query and before the presentation of the information cards. As depicted, the information card 622 is presented on top of the other information cards such that content of the information card 622 is in view on the user interface 610. In some embodiments, the user can view or otherwise access the content of the other information cards by swiping away the information card 622, dragging the information card 622 to another position within the stack of information cards, selecting another one of the information cards, etc. In some embodiments, each of the information cards may correspond to a respective domain (e.g., weather, restaurants, movies, music, navigation, calendar, etc.).

A user may perform various activities regarding the cards in the user interface 610. As shown in FIG. 6, the user is clicking the card 626 with his/her hand 630. It can be understood that other user activities may include swiping a card to remove it, scrolling down the list of cards, dwelling on a card, zooming in or out of a card, etc.

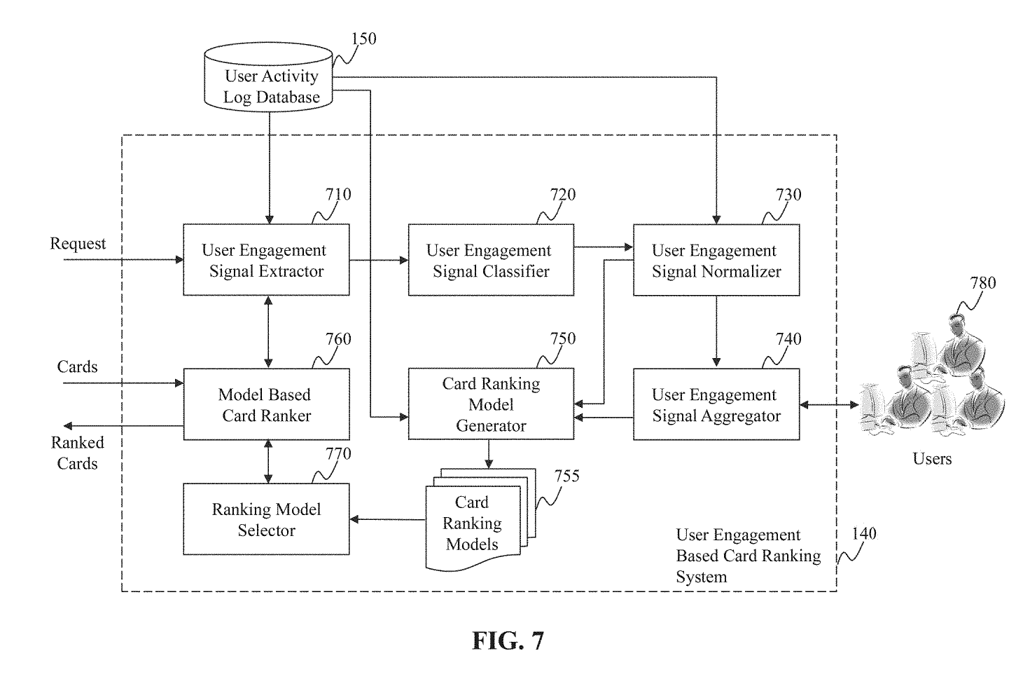

FIG. 7 is a high level exemplary system diagram of a user engagement based card ranking system 140, according to an embodiment of the present teaching. As depicted in FIG. 7, the user engagement based card ranking system 140 in this example comprises a user engagement signal extractor 710, a user engagement signal classifier 720, a user engagement signal normalizer 730, a user engagement signal aggregator 740, a card ranking model generator 750, card ranking models 755 stored therein, a model based card ranker 760, and a ranking model selector 770.

The user engagement signal extractor 710 in this example may receive a request for optimizing a card ranking model. The request may be based on a predetermined timer, come from a manager of the user engagement based card ranking system 140, or come from the card-based information guide system 130. Upon receipt of the request, the user engagement signal extractor 710 may extract user engagement signals from the user activity log database 150. Each user engagement signal may correspond to a card, a (card, query) pair, a (card, context) pair or a set of (card, query, context). The context here can be time or locations. When only context information is provided with no query, it may be the situation of recommendation tasks (known as query-less or proactive search). For simplicity, the rest description will focus on (card, query) pairs while it can be understood that the method disclosed in the present teaching can easily be applied for other situations. The user engagement signal extractor 710 can send the extracted user engagement signals to the user engagement signal classifier 720 for classification.

The user engagement signals may be of different types as shown in FIG. 4. The user engagement signal classifier 720 in this example may classify the user engagement signals extracted by the user engagement signal extractor 710 into various types. In one embodiment, the user engagement signals extracted by the user engagement signal extractor 710 have already been classified into different types when being stored into the user activity log database 150. The user engagement signal classifier 720 can send the classified user engagement signals to the user engagement signal normalizer 730 for normalization.

Because different user engagement signals may have different measurement units, there is a desire to normalize the user engagement signals before combining or aggregating them. The user engagement signal normalizer 730 in this example may obtain different types of user engagement signals from the user engagement signal classifier 720 and determine a normalized user engagement score for each type of user engagement signals. This determination may be based on aggregation statistics of the user engagement signals. For example, the user engagement signal normalizer 730 may compute different aggregation statistics such as MAX/MIN/Average/Median of user engagement signals for different combinations of search or recommendation contexts, such as (card, query), (card, time, query, location), (card, time, location), (card, time), (card, location), etc., with respect to each type of cards and each family of user engagement signals. This computation can be based on data from the user activity log database 150. The user engagement signal normalizer 730 may compute the statistics from large amount of long-term historical data using a high-latency offline component, or compute the statistics from real-time data and update those statistics online using a low-latency online component.

In one embodiment, the user engagement signal normalizer 730 may compute advanced aggregation statistics, and normalize these statistics into comparable scores cross different types of user engagement signals, e.g. by considering the distribution differences of different user engagement signals. In this manner, different user engagement signal scores can be better combined for different purposes. The normalization may be performed by machine learning models.

All user engagement scores computed by the user engagement signal normalizer 730 have the same unit and can be aggregated later for training a card ranking model. The user engagement signal normalizer 730 can send the user engagement scores to the user engagement signal aggregator 740 for aggregation and to the card ranking model generator 750 for training a ranking model.

The user engagement signal aggregator 740 in this example may receive the user engagement scores from the user engagement signal normalizer 730 and aggregate them to generate an aggregated score for each card for each (card, query) pair, for training MLR models. In order to train an MLR model, labeled data and optimizing targets need to be provided. Traditionally the labels or the relevance judgments of (card, query) are obtained through human-annotations, which is very expensive and does not scale-up. Here, the user engagement based card ranking system 140 may directly use some type of relevance scores of (card, query), that are computed as described before, as the labels. In one embodiment, the user engagement signal aggregator 740 can weight each type of relevance scores or user engagement signals of (card, query) to compute a final relevance score or aggregated score for each (card, query) and use it as the label for the MLR model training. In this manner, different types of user engagement signals can be used together for training MLR models. The weights of different types of user engagement signals can be manually defined by intuition, or tuned through offline human judgments. For example, the weights may be generated or tuned by the user engagement signal aggregator 740 using a regression approach, e.g. a linear regression or a logistic regression, based on offline human judgments from the users 780. Because the weights usually do not need to be updated frequently, using human judgments here does not generate much overhead here. Based on the weights, the user engagement signal aggregator 740 can combine the user engagement scores obtained from the user engagement signal normalizer 730 to generate aggregated score for each card or each (card, query) pair, and send the aggregated scores to the card ranking model generator 750.

The card ranking model generator 750 in this example may train a card machine learning ranking (MLR) model, utilizing user-engagement-signal based aggregation statistics, obtained from the user engagement signal normalizer 730, as ranking features of the MLR model. The card ranking model generator 750 may also combine these user engagement signal based features with other family of ranking features, such as the query and query intent features, card features, context features and user attribute features, to rank cards through MLR approaches (or learning-to-rank approaches). The other family of ranking features may come from the user activity log database 150 and/or the card-based information guide system 130.

As discussed above, it is expensive to obtain optimizing targets of an MLR model from human inputs. In this example, the card ranking model generator 750 may directly use some type of user engagement scores obtained from the user engagement signal normalizer 730 as the optimizing label targets, or use the aggregated scores obtained from the user engagement signal aggregator 740 as the optimizing label targets, for training MLR models. The obtained labels can be binary or graded.

After the labeled data are obtained, ranking targets such as MAP or NDCG can be used for training the MLR models, aiming to achieve the best user satisfaction of their outputs. Moreover, the labeled data can be further combined with the size of the cards for designing better offline optimization targets.

In one embodiment, choosing more reliable positive/negative signals such as skip, long dwell click, long browsing time, and reformulations for computing the labels and ranking targets may lead to better online ranking performance. Different strategies can be used to train the MLR models by the card ranking model generator 750 and online experiments can be used to identify and select the best performing model. In one embodiment, the card ranking model generator 750 can train the MLR models periodically, particularly because the products and queries or even user behaviors can change over time.

Based on the input ranking features and the optimizing targets, the card ranking model generator 750 can train to generate MLR models and store the MLR models 755 for future card ranking.

The model based card ranker 760 in this example may receive a set of cards to be ranked, e.g. from the card-based information guide system 130. The set of cards may be search results matching a query submitted by a user or cards recommended to a user without any query. The model based card ranker 760 may obtain user engagement signals related to each of the set of cards, from the user engagement signal extractor 710 or from the user activity log database 150 directly. In addition, the model based card ranker 760 may obtain contextual information related to the set of cards and/or the query, e.g. information shown in FIG. 5, from the user engagement signal extractor 710 or from the user activity log database 150 directly.

The model based card ranker 760 may inform the ranking model selector 770 to select an optimized ranking model from the card ranking models 755. The ranking model selector 770 may select one of the card ranking models 755 based on the user engagement signals, the contextual information, and/or other family of ranking features, such as the query and query intent features, card features, and user attribute features.

Utilizing the selected model obtained from the ranking model selector 770, the model based card ranker 760 can rank the set of cards to generate a ranked list of cards, based on the user engagement information and the context information obtained from the user engagement signal extractor 710 or the user activity log database 150. Then, the model based card ranker 760 can send the ranked list of cards to the card-based information guide system 130, for presentation to a user.

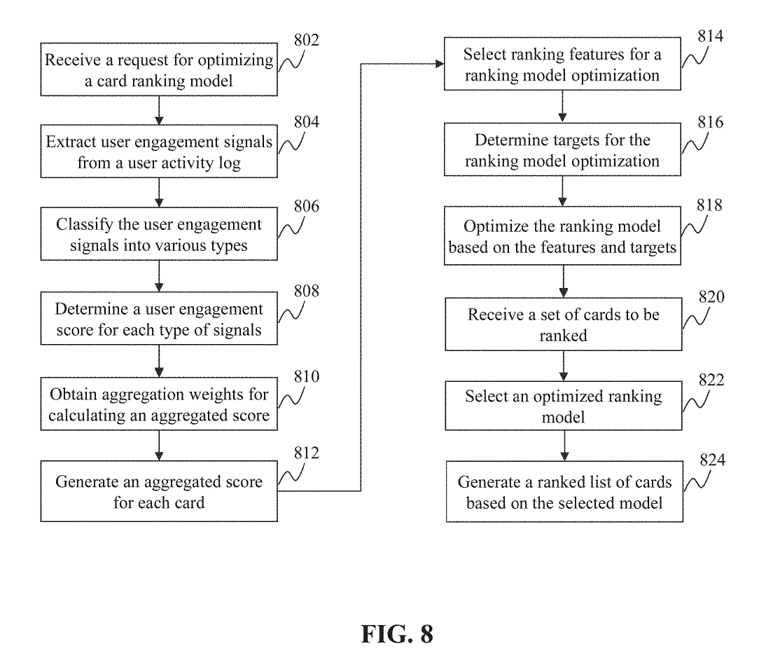

FIG. 8 is a flowchart of an exemplary process performed by a user engagement based card ranking system, e.g. the user engagement based card ranking system 140 in FIG. 7, according to an embodiment of the present teaching. A request is received at 802 for optimizing a card ranking model. User engagement signals are extracted at 804 from a user activity log. The user engagement signals are classified at 806 into various types. A user engagement score is determined at 808 for each type of signal. At 810, aggregation weights are obtained for calculating an aggregated score. The aggregated score for each card or (card, query) pair is generated at 812.

Ranking features are selected at 814 for optimizing or training a ranking model. Optimizing targets are determined at 816 for the ranking model optimization. The ranking model is optimized at 818 based on the ranking features and optimizing targets. At 820, a set of cards to be ranked is received. An optimized ranking model is selected at 822. A ranked list of cards is generated at 824 based on the selected model.

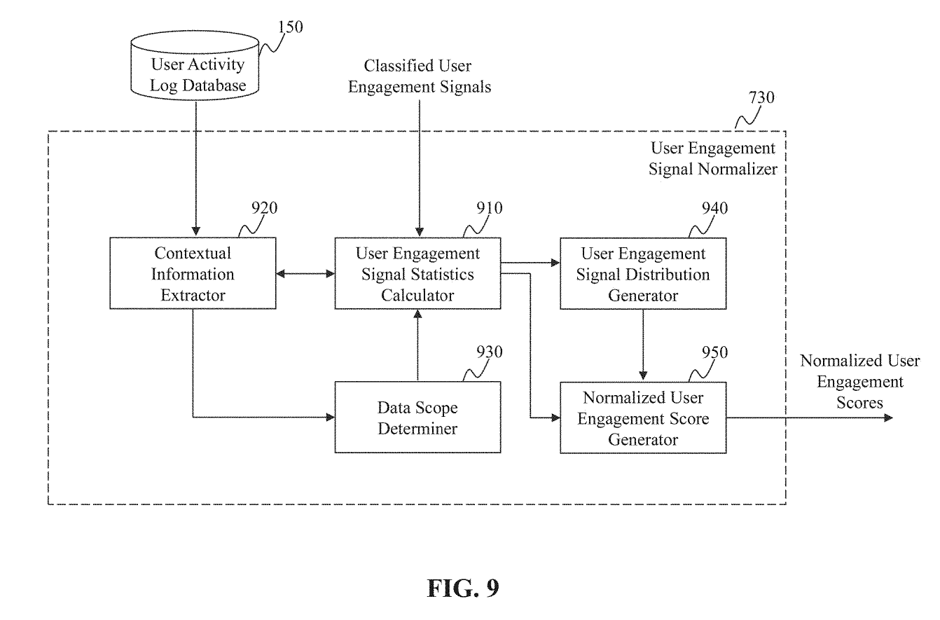

FIG. 9 illustrates an exemplary diagram of a user engagement signal normalizer, e.g. the user engagement signal normalizer 730 in FIG. 7, according to an embodiment of the present teaching. As shown in FIG. 9, the user engagement signal normalizer 730 in this example includes a contextual information extractor 920, a user engagement signal statistics calculator 910, a data scope determiner 930, a user engagement signal distribution generator 940, and a normalized user engagement score generator 950.

The user engagement signal statistics calculator 910 in this example may receive classified user engagement signals from the user engagement signal classifier 720 for calculating user engagement signal statistics. In one embodiment, the user engagement signal statistics calculator 910 may inform the contextual information extractor 920 to extract contextual information related to the user engagement signals from the user activity log database 150.

The contextual information extractor 920 in this example may extract contextual information related to classified user engagement signals, e.g. time and location or other contextual information as shown in FIG. 5. The contextual information extractor 920 may send the contextual information to the data scope determiner 930 for determining a data scope.

The data scope determiner 930 in this example may determine a scope of data to be used for statistics calculation at the user engagement signal statistics calculator 910, based on the contextual information obtained from the contextual information extractor 920. For example, the data scope determiner 930 may determine that the scope of data includes user engagement signals generated in the latest month, in the past week, or in the past day. The data scope determiner 930 may also determine that the scope of data includes user engagement signals related to a group of users or a particular user. The data scope determiner 930 may also determine that the scope of data includes user engagement signals related to user activities happened within a particular time period, at a particular location, through a particular platform, and/or through a particular network. The data scope determiner 930 may send the data scope information to the user engagement signal statistics calculator 910 for calculating the user engagement signal statistics.

The user engagement signal statistics calculator 910 may calculate the user engagement signal statistics based on the classified user engagement signals with a scope determined by the data scope determiner 930 and/or based on the contextual information extracted by the contextual information extractor 920. The user engagement signal statistics calculator 910 may send the calculated user engagement signal statistics to the user engagement signal distribution generator 940 for generating a user engagement signal distribution for each user engagement signal or each type of user engagement signal. The user engagement signal statistics calculator 910 may also send the calculated user engagement signal statistics to the normalized user engagement score generator 950 for generating a normalized user engagement score for each user engagement signal or each type of user engagement signal.

The user engagement signal distribution generator 940 in this example may generate a distribution for each user engagement signal or each type of user engagement signal, e.g. based on the user engagement signal statistics obtained from the user engagement signal statistics calculator 910. The user engagement signal distribution generator 940 can send the distributions to the normalized user engagement score generator 950 for normalizing the user engagement signals.

As discussed before, different types of user engagement signals may have different measurement units. For example, the number of clicks and the dwell time are measured differently. To combine different types of user engagement signals, the normalized user engagement score generator 950 in this example may generate a normalized user engagement score for each user engagement signal or each type of user engagement signal, based on the corresponding distributions of the user engagement signals. Each normalized user engagement score may have a same unit. For example, for each user engagement signal, the normalized user engagement score generator 950 may determine a percentile where the user engagement signal stands in its corresponding distribution, and generate a normalized user engagement score based on the percentile. For example, if the number of clicks for a card is 100 per day, which is larger than the numbers of clicks for 85% of all cards in the user activity log database 150, the normalized user engagement score generator 950 may generate a number of 0.85 or 85 as a normalized user engagement score for the signal of number of clicks. The normalized user engagement score generator 950 may send all of the normalized user engagement scores to the user engagement signal aggregator 740 for aggregation and to the card ranking model generator 750 for ranking model optimization.

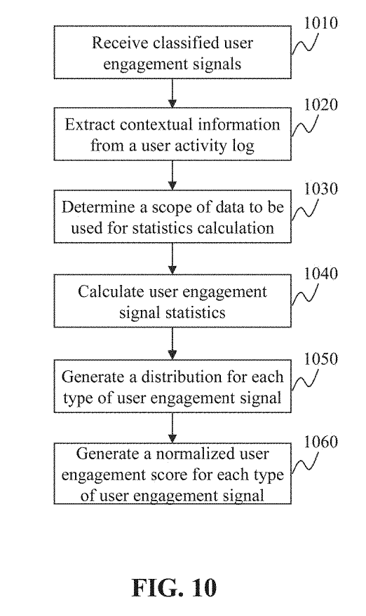

FIG. 10 is a flowchart of an exemplary process performed by a user engagement signal normalizer, e.g. the user engagement signal normalizer 730 in FIG. 9, according to an embodiment of the present teaching. Classified user engagement signals are received at 1010. Contextual information is extracted at 1020 from a user activity log. A scope of data is determined at 1030 to be used for statistics calculation. User engagement signal statistics are calculated at 1040. A distribution is generated at 1050 for each type of user engagement signal. A normalized user engagement score is generated at 1060 for each type of user engagement signal.

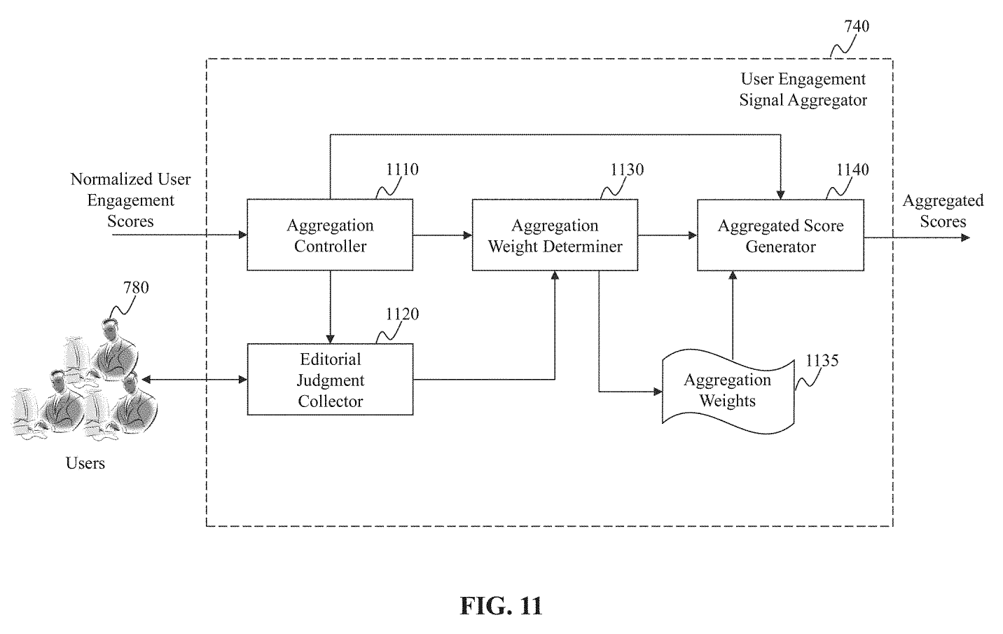

FIG. 11 illustrates an exemplary diagram of a user engagement signal aggregator, e.g. the user engagement signal aggregator 740 in FIG. 7, according to an embodiment of the present teaching. As shown in FIG. 7, the user engagement signal aggregator 740 in this example includes an aggregation controller 1110, an editorial judgment collector 1120, an aggregation weight determiner 1130, some aggregation weights 1135 store therein, and an aggregated score generator 1140.

The aggregation controller 1110 in this example may receive normalized user engagement scores from the user engagement signal normalizer 730. Each normalized user engagement score may correspond to a user activity with respect to a card or a (card, query) pair. The aggregation controller 1110 may determine whether to update aggregation weights 1135, before an aggregation of the normalized user engagement scores. For example, the aggregation controller 1110 may determine to update the aggregation weights 1135, because time is up according to a predetermined time period or because there is a normalized user engagement score corresponding to a new or updated user activity.

When the aggregation controller 1110 determines that the aggregation weights 1135 need to be updated, the aggregation controller 1110 may inform the aggregation weight determiner 1130 to determine or update the aggregation weights 1135. In one embodiment, the aggregation weight determiner 1130 in this example may tune the aggregation weights 1135 based on predefined data based on user experience. In another embodiment, the aggregation weight determiner 1130 may update the aggregation weights 1135 based on collected user inputs from the editorial judgment collector 1120.

The aggregation controller 1110 may inform the editorial judgment collector 1120 to collect the editorial judgments from the users 780. The editorial judgment collector 1120 in this example may send requests to the users 780 for user labels regarding each card in the training data set. For example, the editorial judgment collector 1120 may send a group of (card, query) pairs to the users 780, and request the users 780 to provide a relevance score for each (card, query) pair. These relevance scores can be collected as editorial judgments for aggregation weight calculation. The editorial judgment collector 1120 may send the collected editorial judgments to the aggregation weight determiner 1130 for calculation or update of the aggregation weights 1135.

As discussed before, the aggregation weight determiner 1130 may calculate the aggregation weights 1135 based on a regression approach, using the editorial judgments and the normalized user engagement scores. For example, the aggregation weight determiner 1130 can estimate a regression function by estimating the aggregation weights 1135, such that the regression function with the estimated aggregation weights can map a set of normalized user engagement scores corresponding to each card to a relevance score determined for the card based on the editorial judgments. The aggregation weight determiner 1130 may store the aggregation weights 1135 and/or send the aggregation weights 1135 to the aggregated score generator 1140 for generating an aggregated score for each card or each (card, query) pair.

The aggregated score generator 1140 in this example may generate an aggregated score for each card or each (card, query) pair, based on the aggregation weights 1135. In one situation, when the aggregation controller 1110 determines that the aggregation weights 1135 need to be updated, the aggregation weight determiner 1130 updates the aggregation weights 1135 and sends the updated aggregation weights 1135 to the aggregated score generator 1140. In another situation, when the aggregation controller 1110 determines that the aggregation weights 1135 need not to be updated, the aggregation controller 1110 may directly inform the aggregated score generator 1140 to generate the aggregated scores based on the stored aggregation weights 1135. In either situation, the aggregated score generator 1140 can generate the aggregated scores based on the aggregation weights 1135 and the normalized user engagement scores. The aggregated score generator 1140 can then send the aggregated scores to the card ranking model generator 750 for ranking model optimization.

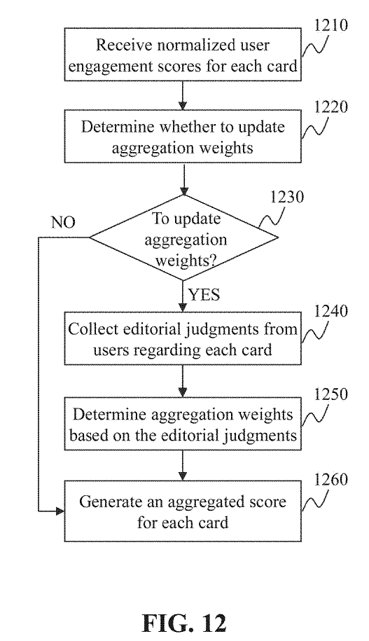

FIG. 12 is a flowchart of an exemplary process performed by a user engagement signal aggregator, e.g. the user engagement signal aggregator 740 in FIG. 11, according to an embodiment of the present teaching. Normalized user engagement scores are received at 1210 for each card or (card, query) pair. At 1220, it is determined whether to update the aggregation weights. The determination result is checked at 1230. If at 1230, the aggregation weights are determined to be updated, the process goes to 1240. Otherwise, if the aggregation weights are determined not to be updated, the process directly goes to 1260.

At 1240, editorial judgments are collected from users regarding each card or each (card, query) pair. Aggregation weights are determined or updated at 1250 based on the editorial judgments. At 1260, an aggregated score is generated for each card or each (card, query) pair.

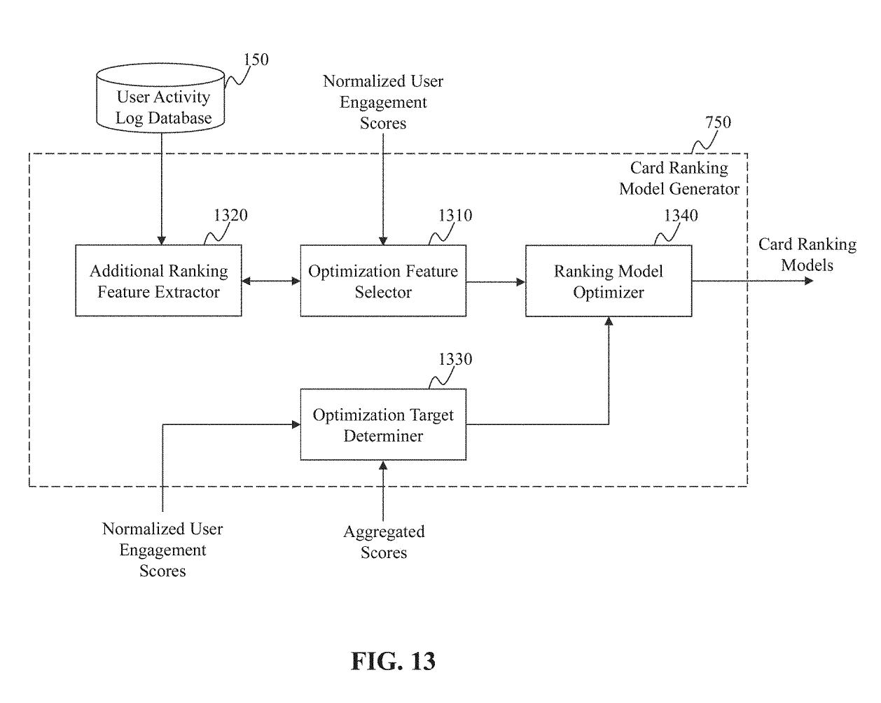

FIG. 13 illustrates an exemplary diagram of a card ranking model generator, e.g. the card ranking model generator 750 in FIG. 7, according to an embodiment of the present teaching. As shown in FIG. 13, the card ranking model generator 750 in this example includes an optimization feature selector 1310, an additional ranking feature extractor 1320, an optimization target determiner 1330, and a ranking model optimizer 1340.

The optimization feature selector 1310 in this example may receive normalized user engagement scores, e.g. from the user engagement signal normalizer 730. The optimization feature selector 1310 may determine whether to utilize additional ranking features other than the user engagement signals, for training the card ranking model. If so, the optimization feature selector 1310 may inform the additional ranking feature extractor 1320 to extract additional ranking features. The additional ranking feature extractor 1320 in this example may extract the additional ranking features from the user activity log database 150. For example, the additional ranking features may include but not limited to: query and query intent features, card features, context features and user attribute features. The additional ranking feature extractor 1320 may send the extracted additional ranking features to the optimization feature selector 1310. The optimization feature selector 1310 can select one or more ranking features from both the received ranking features of the user engagement signals and the additional ranking features. The optimization feature selector 1310 may then send the selected ranking features to the ranking model optimizer 1340 for training the card ranking model.

The optimization target determiner 1330 in this example may receive the normalized user engagement scores from the user engagement signal normalizer 730 and/or the aggregated scores from the user engagement signal aggregator 740. In one embodiment, the optimization target determiner 1330 may determine optimizing targets for the ranking model optimization based on some of the normalized user engagement scores. In another embodiment, the optimization target determiner 1330 may determine optimizing targets for the ranking model optimization based on the aggregated scores. In either embodiment, there is no need to collect user inputs for training the MLR model at the ranking model optimizer 1340.

The ranking model optimizer 1340 in this example may receive the optimizing targets from the optimization target determiner 1330. Following a machine learning method, the ranking model optimizer 1340 may train the card ranking model, based on the ranking features received from the optimization feature selector 1310 and the optimizing targets received from the optimization target determiner 1330. The ranking model optimizer 1340 can store the trained card ranking models and/or send the trained card ranking models for ranking content items, e.g. cards to be presented to a user.

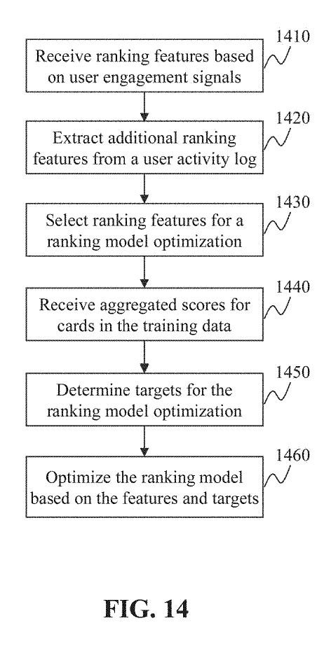

FIG. 14 is a flowchart of an exemplary process performed by a card ranking model generator, e.g. the card ranking model generator 750 in FIG. 13, according to an embodiment of the present teaching. Ranking features are received at 1410 based on user engagement signals. Additional ranking features are extracted at 1420 from a user activity log. One or more ranking features are selected at 1430 for a ranking model optimization. Aggregated scores are received at 1440 for cards in the training data. Optimizing targets are determined at 1450 for the ranking model optimization. At 1460, the ranking model is optimized or trained based on the selected ranking features and optimizing targets.

It can be understood that the order of the steps shown in each of FIG. 8, FIG. 10, FIG. 12, and FIG. 14 may be changed according to different embodiments of the present teaching.

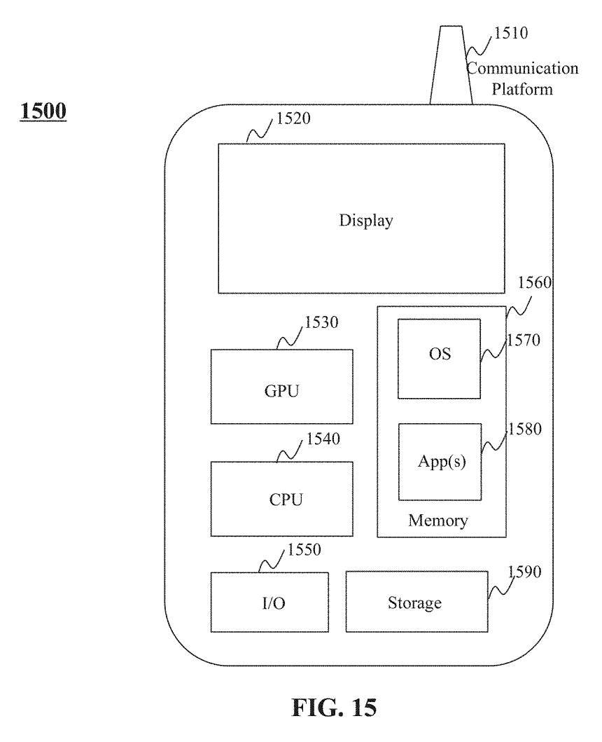

FIG. 15 depicts the architecture of a mobile device which can be used to realize a specialized system implementing the present teaching. In this example, the user device on which a ranked list of content items is presented and interacted-with is a mobile device 1500, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1500 in this example includes one or more central processing units (CPUs) 1540, one or more graphic processing units (GPUs) 1530, a display 1520, a memory 1560, a communication platform 1510, such as a wireless communication module, storage 1590, and one or more input/output (I/O) devices 1550. Any other suitable component, including but not limited to a system bus or a controller (not shown), may also be included in the mobile device 1500. As shown in FIG. 15, a mobile operating system 1570, e.g., iOS, Android, Windows Phone, etc., and one or more applications 1580 may be loaded into the memory 1560 from the storage 1590 in order to be executed by the CPU 1540. The applications 1580 may include a browser or any other suitable mobile apps for receiving content items on the mobile device 1500.

To implement various modules, units, and their functionalities described in the present disclosure, computer hardware platforms may be used as the hardware platform(s) for one or more of the elements described herein (e.g., the user engagement based card ranking system 140 and/or other components within the user engagement based card ranking system 140 as described with respect to FIGS. 1-14). The hardware elements, operating systems and programming languages of such computers are conventional in nature, and it is presumed that those skilled in the art are adequately familiar therewith to adapt those technologies about ranking content items as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

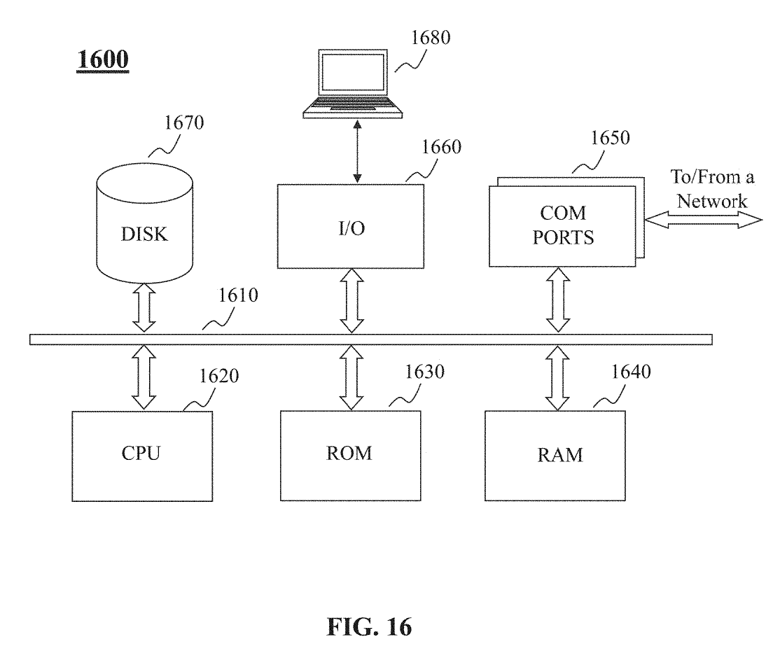

FIG. 16 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1600 may be used to implement any component of the techniques of ranking content items, as described herein. For example, the user engagement based card ranking system 140 and/or its components may be implemented on a computer such as computer 1600, via its hardware, software program, firmware, or a combination thereof. Although only one such computer is shown, for convenience, the computer functions relating to ranking content items as described herein may be implemented in a distributed fashion on a number of similar platforms, to distribute the processing load.

The computer 1600, for example, includes COM ports 1650 connected to and from a network connected thereto to facilitate data communications. The computer 1600 also includes a central processing unit (CPU) 1620, in the form of one or more processors, for executing program instructions. The exemplary computer platform includes an internal communication bus 1610, program storage and data storage of different forms, e.g., disk 1670, read only memory (ROM) 1630, or random access memory (RAM) 1640, for various data files to be processed and/or communicated by the computer, as well as possibly program instructions to be executed by the CPU. The computer 1600 also includes an I/O component 1660, supporting input/output flows between the computer and other components therein such as user interface elements 1680. The computer 1600 may also receive programming and data via network communications.

Hence, aspects of the methods of ranking content items, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer into the hardware platform(s) of a computing environment or other system implementing a computing environment or similar functionalities in connection with ranking content items. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, ranking content items as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform connected to a network for training a ranking model, comprising:
obtaining a set of content items;
obtaining a plurality types of online user activities performed with respect to the set of content items;
determining, for each of the set of content items, a plurality of user engagement scores each of which is determined based on a corresponding one of the plurality types of online user activities;
calculating, for each of the set of content items, an aggregated score based on the plurality of user engagement scores to generate aggregated scores; and
training a ranking model based on the aggregated scores.

2. The method of claim 1, wherein the plurality types of online user activities include user activities based on at least some of the following:
user clicks on the set of content items;
pre-click browsing time of users with respect to the set of content items;
post-click dwell time of users with respect to the set of content items;
reformulation of user requests with respect to the set of content items; and
user abandonment with respect to the set of content items.

3. The method of claim 1, wherein the determining comprises:
obtaining statistics for each type of the plurality types of online user activities;
generating a distribution corresponding to each type of online user activities based on the statistics; and
generating, for each of the set of content items, a user engagement score for each type of online user activities based on the corresponding distribution and the type of online user activities with respect to the content item.

4. The method of claim 1, wherein the calculating comprises:
collecting editorial judgments from users regarding the set of content items;
determining a weight for each of the plurality of user engagement scores based on the editorial judgments to generate aggregation weights using a regression approach; and
calculating, for each of the set of content items, the aggregated score based on the plurality of user engagement scores and the aggregation weights.

5. The method of claim 1, wherein the training comprises:
determining output targets for the ranking model based on the aggregated scores; and
training the ranking model based on the output targets.

6. The method of claim 1, wherein the training comprises:
determining input features for the ranking model based on the plurality types of online user activities and contextual information about the plurality types of online user activities; and
training the ranking model based on the input features.

7. The method of claim 1, further comprising:
receiving a list of content items to be presented to an online user; and
ranking the list of content items based on the ranking model and a plurality types of historical user activities from the online user related to the list of content items.

8. A system, having at least one processor, storage, and a communication platform connected to a network for training a ranking model, comprising:
a user engagement signal extractor configured for:
obtaining a set of content items, and
obtaining a plurality types of online user activities performed with respect to the set of content items;
a user engagement signal normalizer configured for determining, for each of the set of content items, a plurality of user engagement scores each of which is determined based on a corresponding one of the plurality types of online user activities;
a user engagement signal aggregator configured for calculating, for each of the set of content items, an aggregated score based on the plurality of user engagement scores to generate aggregated scores; and
a card ranking model generator for training a ranking model based on the aggregated scores.

9. The system of claim 8, wherein the plurality types of online user activities include user activities based on at least some of the following:
user clicks on the set of content items;
pre-click browsing time of users with respect to the set of content items;
post-click dwell time of users with respect to the set of content items;
reformulation of user requests with respect to the set of content items; and
user abandonment with respect to the set of content items.

10. The system of claim 8, wherein the user engagement signal normalizer comprises:
a user engagement signal statistics calculator configured for obtaining statistics for each type of the plurality types of online user activities;
a user engagement signal distribution generator configured for generating a distribution corresponding to each type of online user activities based on the statistics; and
a normalized user engagement score generator configured for generating, for each of the set of content items, a user engagement score for each type of online user activities based on the corresponding distribution and the type of online user activities with respect to the content item.

11. The system of claim 8, wherein the user engagement signal aggregator comprises:
an editorial judgment collector configured for collecting editorial judgments from users regarding the set of content items;
an aggregation weight determiner configured for determining a weight for each of the plurality of user engagement scores based on the editorial judgments to generate aggregation weights using a regression approach; and
an aggregation score generator configured for calculating, for each of the set of content items, the aggregated score based on the plurality of user engagement scores and the aggregation weights.

12. The system of claim 8, wherein the card ranking model generator comprises:
an optimization target determiner configured for determining output targets for the ranking model based on the aggregated scores; and
a ranking model optimizer configured for training the ranking model based on the output targets.

13. The system of claim 8, wherein the card ranking model generator comprises:
an optimization feature selector configured for determining input features for the ranking model based on the plurality types of online user activities and contextual information about the plurality types of online user activities; and
a ranking model optimizer configured for training the ranking model based on the input features.

14. The system of claim 8, further comprising a model based card ranker configured for:
receiving a list of content items to be presented to an online user; and
ranking the list of content items based on the ranking model and a plurality types of historical user activities from the online user related to the list of content items.

15. A machine-readable tangible and non-transitory medium having information for training a ranking model, wherein the information, when read by the machine, causes the machine to perform the following:
obtaining a set of content items;
obtaining a plurality types of online user activities performed with respect to the set of content items;
determining, for each of the set of content items, a plurality of user engagement scores each of which is determined based on a corresponding one of the plurality types of online user activities;
calculating, for each of the set of content items, an aggregated score based on the plurality of user engagement scores to generate aggregated scores; and
training a ranking model based on the aggregated scores.

16. The medium of claim 15, wherein the plurality types of online user activities include user activities based on at least some of the following:
user clicks on the set of content items;
pre-click browsing time of users with respect to the set of content items;
post-click dwell time of users with respect to the set of content items;
reformulation of user requests with respect to the set of content items; and
user abandonment with respect to the set of content items.

17. The medium of claim 15, wherein the determining comprises:
obtaining statistics for each type of the plurality types of online user activities;
generating a distribution corresponding to each type of online user activities based on the statistics; and
generating, for each of the set of content items, a user engagement score for each type of online user activities based on the corresponding distribution and the type of online user activities with respect to the content item.

18. The medium of claim 15, wherein the calculating comprises:
collecting editorial judgments from users regarding the set of content items;
determining a weight for each of the plurality of user engagement scores based on the editorial judgments to generate aggregation weights using a regression approach; and
calculating, for each of the set of content items, the aggregated score based on the plurality of user engagement scores and the aggregation weights.

19. The medium of claim 15, wherein the training comprises:
determining output targets for the ranking model based on the aggregated scores; and
training the ranking model based on the output targets.

20. The medium of claim 15, wherein the training comprises:
determining input features for the ranking model based on the plurality types of online user activities and contextual information about the plurality types of online user activities; and
training the ranking model based on the input features.

21. The medium of claim 15, wherein the information, when read by the machine, further causes the machine to perform the following:
receiving a list of content items to be presented to an online user; and
ranking the list of content items based on the ranking model and a plurality types of historical user activities from the online user related to the list of content items.
